(19) United States
(12) Patent Application Publication
(10) Pub. No.: US 2016/0082555 A1
(43) Pub. Date: Mar. 24, 2016

(54) MANUFACTURING METHOD OF HEAT EXCHANGER AND REFRIGERATION CYCLE APPARATUS

(71) Applicant: MITSUBISHI ELECTRIC CORPORATION, Tokyo (JP)

(72) Inventors: Mitsuhiro NISHIMURA, Tokyo (JP); Wataru SUZUKI, Tokyo (JP); Nobuaki MIYAKE, Tokyo (JP); Tomohiko TAKAHASHI, Tokyo (JP); Yoshihide ASAI, Tokyo (JP)

(21) Appl. No.: 14/888,800

(22) PCT Filed: May 27, 2014
(86) PCT No.: PCT/JP2014/064024

§ 371 Date: Nov. 3, 2015

(30) Foreign Application Priority Data
May 27, 2013 (JP) 2013-111130

(51) Int. Cl. B23P 15/26; F25B 13/00

(52) U.S. Cl. CPC B23P 15/26; F25B 13/00

(57) ABSTRACT

There is provided a manufacturing method of a heat exchanger including a plurality of flat heat transfer tubes which have a flat shape in cross-section, and a plurality of thin-plate fins which have cutouts 4 formed so as to match the shape of the flat heat transfer tube and fin collars formed so as to be raised along the edges of the cutouts, and which are arrayed at predetermined intervals in a flow passage direction of the flat heat transfer tube, wherein the fin collar is formed so as to have a fastening allowance of 0.15 mm relative to the outer width dimension of the flat heat transfer tube.

### TECHNICAL FIELD

The present invention relates to a manufacturing method of a heat exchanger etc. which is used for an air-conditioning apparatus, a refrigeration apparatus, or the like. In particular, the present invention relates to a fin tube-type heat exchanger etc.

### BACKGROUND ART

Examples of a heat exchanger used for an air-conditioning apparatus, a refrigeration apparatus, or the like include a fin tube-type heat exchanger configured by extending a plurality of heat transfer tubes through a plurality of thin-plate fins which are stacked (arrayed at regular intervals) (e.g., see Patent Literature 1). Among such fin tube-type heat exchangers is one formed by inserting thin-plate fins across flat heat transfer tubes, which have a flat shape in cross-section, through cutouts formed in the thin-plate fins so as to come into close contact with the flat heat transfer tubes (e.g., see Patent Literature 2). The flat heat transfer tubes and the thin-plate fins are made of a material, for example, aluminum, an aluminum-containing alloy, etc.

### CITATION LIST

### Patent Literature

Patent Literature 1: Japanese Patent Laid-Open No. 10-89870
Patent Literature 2: Japanese Patent Laid-Open No. 2012-172892

### SUMMARY OF INVENTION

### Technical Problem

For example, the fin tube-type heat exchanger with cutouts formed in the thin-plate fins often has fin collars which are formed by cutting and raising edge portions of the cutouts from the plate surface. The fin collar serves, for example, to keep the regular intervals between the thin-plate fins as well as to bring the thin-plate fin and the flat heat transfer tube into close contact with each other. When forming the fin collar, a punch and a die are used to mold the fin collar into desired shape and dimensions.

Here, when forming a fin collar made of a material such as aluminum, a phenomenon such as spring-back, in which the molded fin collar returns slightly toward the original position, occurs upon separation of the punch and the die from the thin-plate fin after molding. If spring-back etc. occurs, the molded fin collars vary in shape and dimensions, which may unstabilize the length of a fastening allowance of the fin collar in a portion into which the flat heat transfer tube is inserted in close contact.

As a result, in some cases, the thin-plate fin is easily displaced when the thin-plate fin is inserted across the flat heat transfer tubes, so that the fin pitch between the stacked thin-plate fins is disrupted.

The present invention has been devised to solve the above problem, and an object of the invention is to obtain a manufacturing method of a heat exchanger etc. which can suppress displacement of fins when the fins are inserted across flat heat transfer tubes.

### Solution to Problem

According to the present invention, there is provided a manufacturing method of a heat exchanger including a plurality of flat heat transfer tubes which have a flat shape in cross-section, and a plurality of fins which have cutouts formed so as to match a shape of the flat heat transfer tube and fin collars formed so as to be raised along edges of the cutouts, and which are arrayed at predetermined intervals in a flow passage direction of the flat heat transfer tube, wherein the fin collar is formed so as to have a fastening allowance of 0.15 mm relative to an outer width dimension of the flat heat transfer tube.

### Advantageous Effects of Invention

According to the present invention, since the fin collar is molded so as to have a fastening allowance of 0.15 mm relative to the outer width dimension of the flat heat transfer tube, it is possible to manufacture a high-performance heat exchanger that is prevented from deteriorating the performance thereof.

### BRIEF DESCRIPTION OF DRAWINGS

FIG. 1 is a perspective view showing the configuration of a heat exchanger according to Embodiment 1 of the present invention.

FIG. 2 is a view showing the relation between a flat heat transfer tube 1 and a thin-plate fin 2 of Embodiment 1 of the present invention.

FIG. 3 is a view illustrating pressing steps by a pressing device during production of the thin-plate fin 2 of the heat exchanger.

FIG. 4 is a view illustrating a pressing step of forming a fin collar 21 and an open hole 4d.

FIG. 5 is a view showing a mounting step of mounting the thin-plate fins 2 onto the flat heat transfer tubes 1.

FIG. 6 is a view illustrating changes in the thin-plate fin 2 and the flat heat transfer tube 1 when a fastening allowance of the fin collar 21 is too small.

FIG. 7 is a view illustrating a manufacturing method for forming the fin collar 21 and the open hole 4d according to Embodiment 1 of the present invention.

FIG. 8 is a view illustrating the shape of the fin collar 21 and the dimensions of the open hole 4d formed in Embodiment 1 of the present invention.

FIG. 9 is a view showing the configuration of a refrigeration cycle apparatus according to Embodiment 2 of the present invention.

### DESCRIPTION OF EMBODIMENTS

### Embodiment 1.

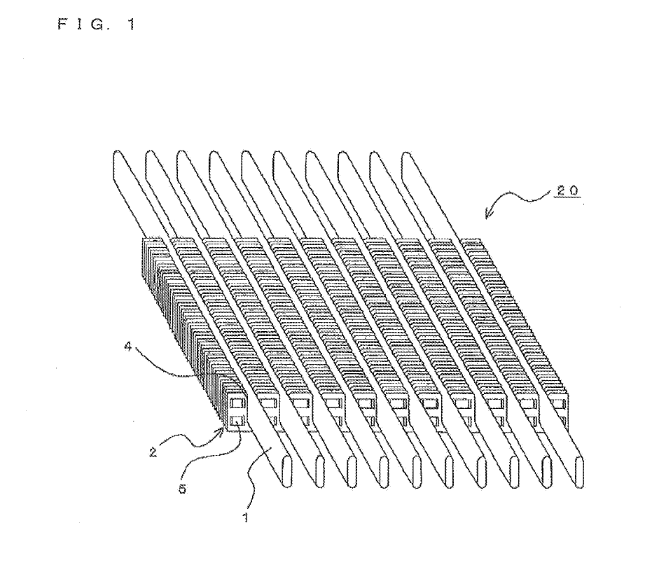

FIG. 1 is a perspective view showing the configuration of a heat exchanger according to Embodiment 1 of the present invention. A heat exchanger 20 of Embodiment 1 is a fin tube-type heat exchanger having a plurality of arrayed thin-plate fins 2 and a plurality of arrayed flat heat transfer tubes 1.

The thin-plate fins 2 are substantially rectangular fins stacked (arrayed) at a predetermined fin pitch. Here, the long-side direction and the short-side direction of the thin-plate fin 2 will be referred to as a longitudinal direction and a short direction, respectively. A plurality of cut-and-raised slits 5, which are open in a circulation direction of air flowing between the thin-plate fins 2, are formed on the surface of a thin-plate portion (plate surface) of the thin-plate fins 2. Forming the cut-and-raised slits 5 in the thin-plate fin 2 allows division and renewal of a thermal boundary layer created on the surface of the thin-plate fin 2. Thus, the efficiency of heat exchange between the thin-plate fins 2 and air flowing between the thin-plate fins 2 can be enhanced.

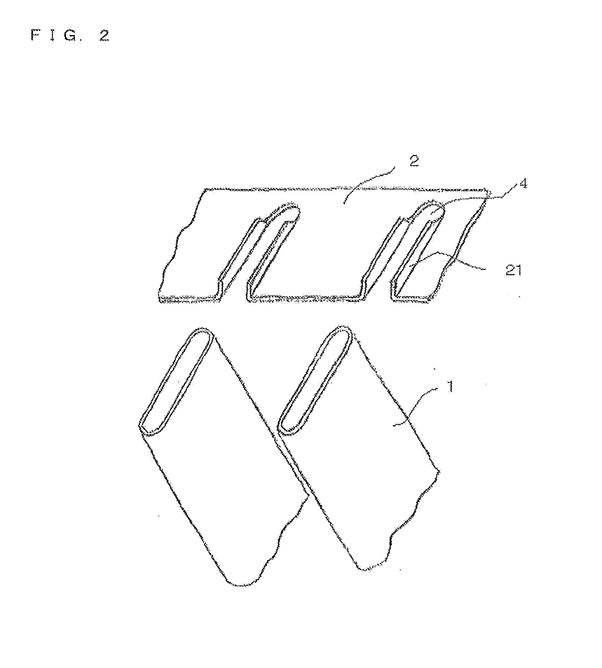

FIG. 2 is a view showing the relation between the flat heat transfer tube 1 and the thin-plate fin 2 in Embodiment 1 of the present invention. A plurality of cutouts 4 are formed at predetermined intervals on the side of one edge (on one side) in the longitudinal direction of the thin-plate fin 2. The spaces formed in these cutouts 4 serve as insert holes, into which the flat heat transfer tubes 1 are inserted (fitted). For this purpose, the cutout 4 has a U-shape corresponding to the cross-sectional shape of the flat heat transfer tube 1. At the edge of the U-shaped cutout 4 (insert hole), a fin collar 21, which is formed so as to be raised from the thin-plate portion (plate surface) as shown in FIG. 2, is provided, for example, to enhance the contact between the thin-plate fin 2 and the flat heat transfer tube 1.

The flat heat transfer tube 1 is a flat pipe having a cross-section with linear long-side portions and curved, for example, semicircular short-side portions. The flat heat transfer tube 1 is in close contact with the thin-plate fin 2 through the U-shaped cutout 4 of the thin-plate fin 2. Since the cutouts 4 are formed at predetermined intervals in the thin-plate fin 2, the flat heat transfer tubes 1 are disposed at predetermined intervals along the longitudinal direction of the thin-plate fin 2. Refrigerant, which exchanges heat with air flowing between the thin-plate fins 2, flows inside the flat heat transfer tubes 1. The refrigerant flows along a direction in which the thin-plate fins 2 are arrayed.

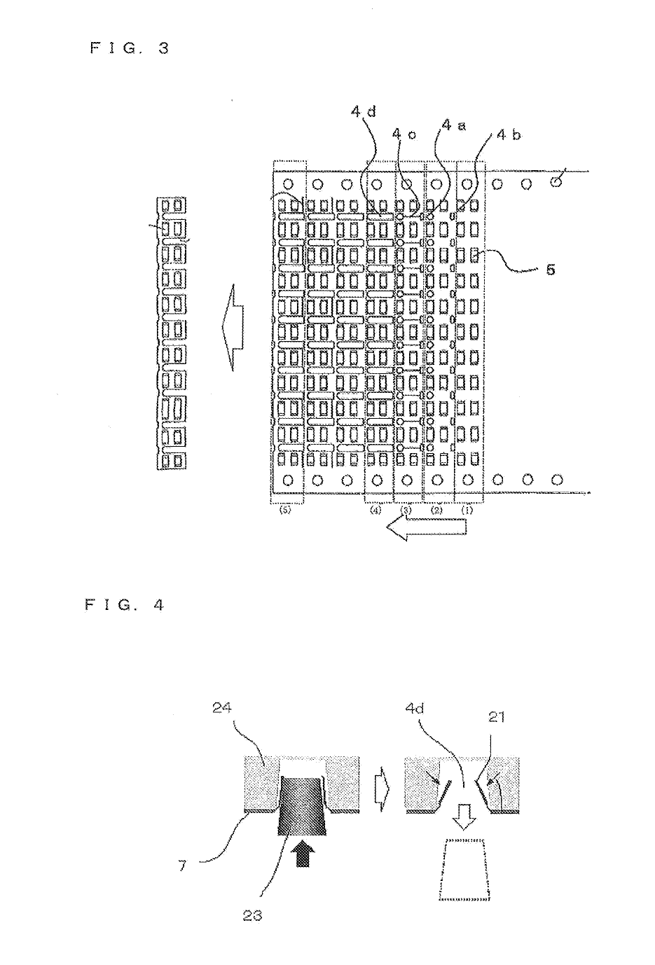

FIG. 3 is a view illustrating pressing steps by a pressing device during production of the thin-plate fin 2 of the heat exchanger. The thin-plate fin 2 is typically produced by processing a thin-plate member such as an aluminum thin plate, wound on a reel in a hoop shape, by means of a progressive pressing device. Specifically, first, a plurality of pilot holes are formed in the vicinity of the end of the thin plate along a feed direction of the thin plate. With pins etc. inserted in the pilot holes formed, the thin plate is intermittently fed inside the progressive pressing device. The progressive pressing device is provided with a plurality of molds along the feed direction of the thin plate, and while intermittently feeding the thin plate inside the progressive pressing device, the progressive pressing device sequentially performs a pressing process with these molds to form the thin-plate fins 2 to be inserted in close contact with the flat heat transfer tubes 1.

Next, each pressing step of the progressive pressing device will be described. First, in a pressing step (1), the cut-and-raised slits 5 are formed in the thin plate ((1) in FIG. 3). In the next pressing step (2), a circular open hole 4a and a rectangular open hole 4b, which become the ends of the open hole (slit) 4d, are formed in order to form the open hole 4d to be the base of the U-shaped cutout 4 ((2) in FIG. 3). Then, in the next pressing step (3), a cut 4c is formed so as to extend between the circular open hole 4a and the rectangular open hole 4b ((3) in FIG. 3). In the next pressing step (4), a portion in the vicinity of the cut 4c is cut and raised to form the fin collar 21 and the open hole 4d ((4) in FIG. 3). Then, in the final pressing step (5) of the progressive pressing device, an outer peripheral part of the thin plate is cut off to produce the thin-plate fin 2 ((5) in FIG. 3). In this way, the thin-plate fin 2 having the plurality of U-shaped cutouts 4, into which the flat heat transfer tubes 1 are to be inserted in close contact, is produced. Here, in some cases, the pressing step (5) involves only formation of a cut at a position to be a portion of the outer peripheral part of the thin-plate fin 2, and the outer peripheral part is cut off in a later step to produce the thin-plate fin 2.

FIG. 4 is a view illustrating the pressing step of forming the fin collar 21 and the open hole 4d. First, the area of the cut 4c, which has been formed in the above-described pressing step (3) so as to extend between the circular open hole 4a and the rectangular open hole 4b, of the thin plate intermittently fed is pushed out by a punch 23 toward a die 24 in the progressive pressing device. Thus, through the shapes of the outer surface of the punch 23 and the inner surface of the die 24, the open hole 4d to be the U-shaped cutout 4 is formed. Meanwhile, in a peripheral part of the open hole 4d, the fin collar 21 is molded by bending and forming (bending processing) through the tapered shape of the outer surface of the punch 23 and the tapered shape of the inner surface of the die 24. As there are a plurality of punches 23 and the dies 24 disposed for one thin plate, the plurality of open holes 4d and fin collars 21 are formed in one thin plate.

Since the punch 23 and the die 24 have a tapered shape, when the punch 23 is separated from (pulled out of) the die 24, the angle of the portion where the fin collar 21 is bent and formed (the root of the fin collar 21) is smaller than 90 degrees. Then, this angle changes due to spring-back, becoming smaller than the angle of the tapered shape of the outer surface of the punch 23 and larger than the angle of the tapered shape of the inner surface of the die 24. As a result, as shown in FIG. 4, the dimension of the open hole 4d to be the U-shaped cutout 4, into which the flat heat transfer tube 1 is inserted in close contact, becomes narrower from the bent portion of the thin plate toward the leading end of the fin collar 21.

The amount of this change due to spring-back is difficult to precisely predict, since it varies due to slight difference, for example, in material, thermal refining, and thickness of the thin plate, as well as in pressure and temperature applied during molding by the punch 23 and the die 24.

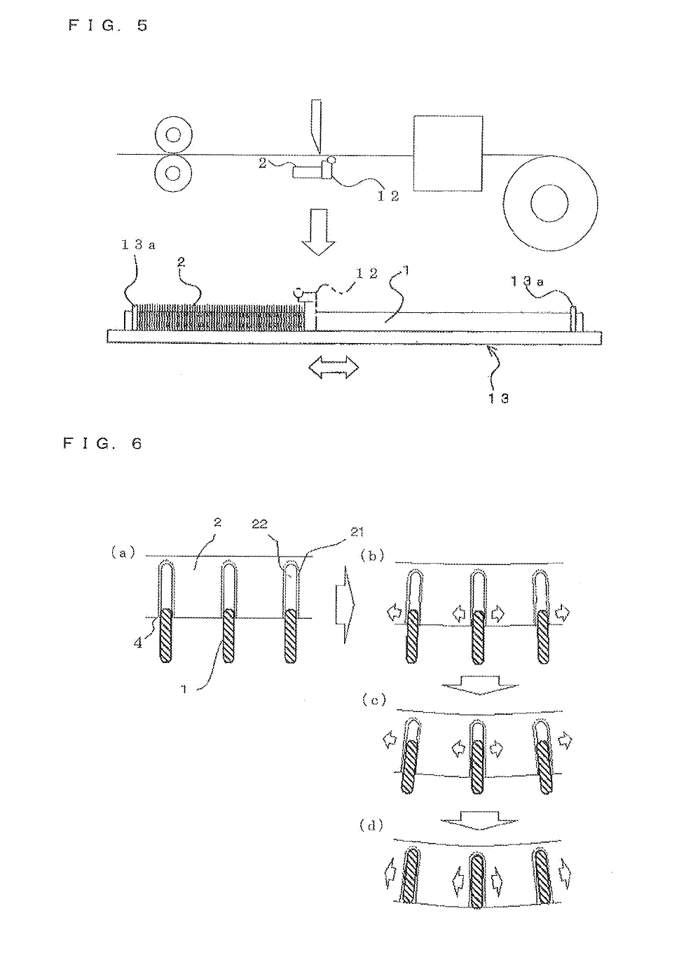

FIG. 5 is a view showing a mounting step of mounting the thin-plate fins 2 onto the flat heat transfer tubes 1. For example, the thin-plate fins 2 produced are mounted onto the flat heat transfer tubes 1 as follows. An insert device 12 for the flat heat transfer tubes 1 and the thin-plate fins 2 in a manufacturing line of the heat exchanger has a table 13. On the upper surface of this table 13, the plurality of flat heat transfer tubes 1 are disposed at predetermined intervals and fixed with a fixing jig 13a. Brazing filler metal is applied to the surface of the flat heat transfer tubes 1 disposed on the table 13. Here, the table 13 includes, for example, a direct-acting actuator (e.g., an actuator driven by an electric motor such as a servomotor), and is structured so as to be movable along the pipe axial direction of the flat heat transfer tube 1 (in the stacking direction of the thin-plate fins 2).

The insert device 12 is provided above the table 13. The insert device 12 includes a holding mechanism which holds the thin-plate fins 2 cut in the above-described pressing step (5), a rotating mechanism (e.g., a mechanism using a cam or an electric motor such as a servomotor) which rotates the thin-plate fins 2 held with the open-side ends of the U-shaped cutouts 4 facing downward, and a moving mechanism which moves up and down the holding mechanism and the rotating mechanism through a direct-acting actuator, for example.

The insert device 12 holds the thin-plate fin 2 cut by the pressing device in the pressing step, rotates the thin-plate fin 2 held with the open-side ends of the cutouts 4 facing downward, and lowers the thin-plate fin 2 onto the table 13. As the flat heat transfer tubes 1 are fitted into the cutouts 4 of the thin-plate fin 2 lowered, the flat heat transfer tubes 1 can be inserted in the direction of the long axis in cross-section, and the thin-plate fin 2 can be inserted and mounted on the plurality of flat heat transfer tubes 1 disposed on the table 13.

The table 13 moves in the pipe axial direction of the flat heat transfer tube 1 during the period from mounting of one thin-plate fin 2 onto the flat heat transfer tubes 1 until insertion of the next thin-plate fin 2 across the flat heat transfer tubes 1 by the insert device 12. Then, the mounting step of the thin-plate fin 2 is repeated. The plurality of thin-plate fins 2 are sequentially mounted and stacked across the flat heat transfer tubes 1 to be assembled into a heat exchanger.

Here, as described above, the fin collar 21 molded tries to return to its original position by spring-back. The amount of this change ranges from 0.1 mm to 0.25 mm, for example. Accordingly, a fastening allowance of the fin collar 21 into which the flat heat transfer tube 1 is inserted in close contact (the difference between the width in the short direction of the flat heat transfer tube 1 and the width of the space portion formed by the cutout 4 (clearance between raised portions of the fin collar 21); a force with which the fin collar 21 comes into contact with the flat heat transfer tube 1) also changes within the range from 0.1 mm to 0.25 mm. Such an amount of change makes it difficult to insert the plurality of thin-plate fins 2 in close contact with the plurality of flat heat transfer tubes 1 stably with an equal fastening allowance (contact force).

For example, if the fastening allowance of the fin collar 21 is as large as 0.1 mm, the contact force between the fin collar 21 and the flat heat transfer tube 1 is reduced. As a result, the thin-plate fin 2 is displaced easily during the above-described mounting step, so that the pitch between the stacked thin-plate fins 2 is disrupted. Thus, the air passage resistance increases and the performance of the heat exchanger may deteriorate.

On the other hand, for example, if the fastening allowance of the fin collar 21 is as small as 0.25 mm, the thin-plate fin 2 may deform in the course of the above-described mounting step. This results in inclination of one or more flat heat transfer tubes 1 among the plurality of flat heat transfer tubes 1 disposed at the predetermined intervals on the table 13, so that the thin-plate fins 2 can no longer be inserted.

FIG. 6 is a view illustrating changes in the thin-plate fin 2 and the flat heat transfer tube 1 when the fastening allowance of the fin collar 21 is too small. For example, in a stage (FIG. 6(a)) where the thin-plate fin 2 is slightly inserted across the flat heat transfer tubes 1, the long side of the thin-plate fin 2 is linear and the flat heat transfer tubes 1 are standing perpendicularly to the thin-plate fin 2. However, as the thin-plate fin 2 is further inserted across the flat heat transfer tubes 1 (FIG. 6(b) to FIG. 6(d)), the U-shaped cutouts 4 are pushed wide open by the flat heat transfer tubes 1 due to the elasticity in the fastening allowance of the fin collar 21 molded in the edge portion of the U-shaped cutout 4, so that the long side of the thin-plate fin 2 warps into a fan shape.

Among the plurality of flat heat transfer tubes 1, which are disposed at a regular pitch, those flat heat transfer tubes 1 located on the outer side are inclined to a larger degree than the flat heat transfer tube 1 disposed at the center due to the force with which the long side of the thin-plate fin 2 warps into a fan shape. This change is amplified as the thin-plate fin 2 is further inserted and stacked across the flat heat transfer tubes 1.

If the inclination of the flat heat transfer tubes 1 increases and exceeds a certain amount, the insert device 12 can no longer insert the thin-plate fins 2 across the flat heat transfer tubes 1, resulting in jamming or failure of the insert device 12. In some cases, the force applied to the thin-plate fin 2 while being inserted across the flat heat transfer tubes 1 causes deformation or twisting of the thin-plate fin 2. As a result, the air passage resistance in the heat exchanger increases and the heat exchange efficiency decreases.

To prevent inclination of the flat heat transfer tubes 1, in a conventional practice, for example, a restraining jig etc. is mounted on the flat heat transfer tubes 1 disposed at a regular pitch before the thin-plate fin 2 is inserted so as to forcibly hold the flat heat transfer tubes 1 in a state of standing parallel to the insert direction of the thin-plate fin 2. In this state, a predetermined number of thin-plate fins 2 are mounted on the flat heat transfer tubes 1 lying on the table 13, and the mounting step of the thin-plate fins 2 using the insert device 12 and the table 13 is completed. After completion of the mounting step, the restraining jig (not shown) having been forcibly holding the flat heat transfer tubes 1 is removed, and these flat heat transfer tubes 1 and thin-plate fins 2 are heated and brazed in a furnace.

Here, if the fastening allowance is too small, the thin-plate fin 2 assumes a fan shape upon removal of the restraining jig, and the flat heat transfer tubes 1 are inclined while remaining in close contact with the thin-plate fin 2. The heat exchanger brazed and fixed in this state has a warped and distorted shape as a whole. If such a heat exchanger is assembled as an air-conditioning apparatus or a refrigeration apparatus, it may become impossible to mount refrigerant pipes which connect the flat heat transfer tubes 1 with one another. Moreover, it may become impossible to connect and fix the heat exchanger on the main body of the air-conditioning apparatus or the refrigeration apparatus.

Conversely, if the fastening allowance is too large, not only is there a minute clearance left between the flat heat transfer tube 1 and the thin-plate fin 2, but also the pitch between the stacked thin-plate fins 2 is disrupted and the thin-plate fins 2 are brazed and fixed with narrow intervals between adjacent thin-plate fins 2, so that the air passage resistance increases and the performance of the heat exchanger deteriorates. In Embodiment 1, therefore, the heat exchanger 20 is produced by the following steps.

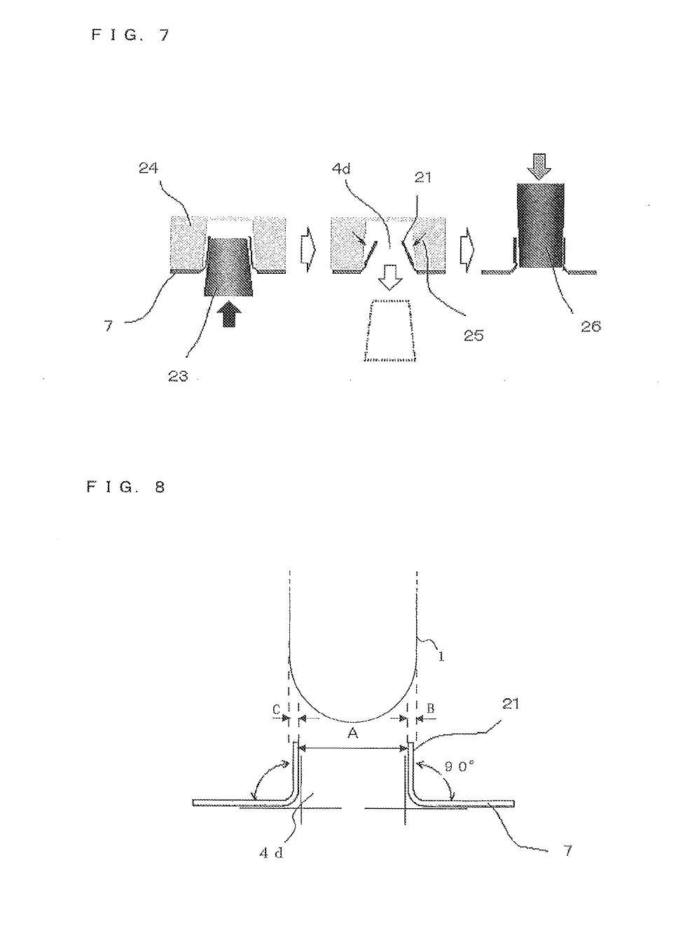

FIG. 7 is a view illustrating a manufacturing method for forming the fin collar 21 and the open hole 4d according to Embodiment 1 of the present invention. The open hole 4d according to this embodiment undergoes a molding step in which the area of the cut 4c, which is formed in the above-described pressing step (3) so as to extend between the circular open hole 4a and the rectangular open hole 4b, is pushed out by the punch 23 toward the die 24. This embodiment further includes a step of remolding the fin collar 21 and the open hole 4d by a restriking punch 26 after pushing out and bending and molding them by the punch 23 and the die 24. The restriking punch 26 punches the thin plate from the side opposite to the surface punched by the punch 23. Since the restriking punch 26 also has a tapered shape, even if the clearance between the raised portions of the fin collar 21 (the width of the fin collar 21) which come in close contact with the surfaces of the long sides in cross-section of the flat heat transfer tube 1 has become narrow due to spring-back, the restriking punch 26 can be inserted into the clearance to enlarge the width.

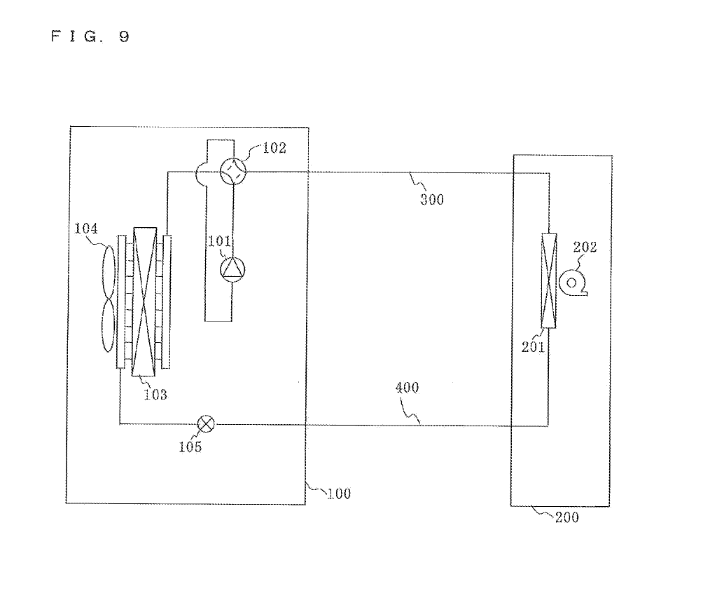

FIG. 8 is a view illustrating the shape of the fin collar 21 and the dimensions of the open hole 4d formed in Embodiment 1 of the present invention. Since Embodiment 1 includes the step of remolding the fin collar 21 and the open hole 4d with the restriking punch 26, the shape, the dimensions, etc. of the fin collar 21 can be optimized for inserting the flat heat transfer tube 1 in close contact with the fin collar 21. Specifically, the width dimension A of the fin collar 21 shown in FIG. 8 should be given a fastening allowance of 0.15 mm relative to the outer width dimension of the flat heat transfer tube 1. However, as described above, as long as the fastening allowance does not cause adverse effects due to being too large (0.1 mm) or too small (0.25 mm), it is included in the allowable range of the dimension of 0.15 mm. Here, the width dimension A of the fin collar 21 is the length between the raised portions of the fin collar 21 which come into close contact with the surfaces of the long sides in cross-section of the flat heat transfer tube 1 (this length is also the width dimension of the cutout 4). The fastening allowance is the difference between the width dimension of the fin collar 21 and the outer width dimension of the flat heat transfer tube 1 (B+C in FIG. 8). The angle of the portion of the fin collar 21 which is bent and formed should be 90 degrees (the fin collar 21 should rise in a direction perpendicular to the plate surface). In this case, the raised portions of the fin collar 21 which come into close contact with the surfaces of the long sides in cross-section of the flat heat transfer tube 1 are parallel to each other. Accordingly, the width dimension (the width dimension A in FIG. 8) is constant throughout the fin collar 21.

The amount of change after bending and forming of the fin collar 21 is minute. Thus, when the plurality of thin-plate fins 2 are inserted across the plurality of flat heat transfer tubes 1, the fastening allowances of the fin collars 21, into which the flat heat transfer tubes 1 are inserted in close contact, become stably equal.

Thus, according to the manufacturing method of a heat exchanger of Embodiment 1, since the fin collar 21 and the open hole 4d are remolded by the restriking punch 26, the U-shaped cutout 4, through which the thin-plate fin 2 is inserted across the flat heat transfer tube 1, is not pushed wide open by the flat heat transfer tube 1. Accordingly, since no warpage in the longitudinal direction of the thin-plate fins 2 nor inclination of the flat heat transfer tubes 1 under the influence of the warpage occurs, it is possible to stably insert and mount the thin-plate fins 2 without restraining the flat heat transfer tubes 1 with a restraining jig etc. in a stage before inserting the thin-plate fins 2 across the flat heat transfer tubes 1. Moreover, no deformation nor twisting of the thin-plate fins 2 is caused by the force applied to the thin-plate fins 2 while being inserted across the flat heat transfer tubes 1. Thus, since performance deterioration of the heat exchanger can be suppressed, a high-performance heat exchanger can be obtained.

Since it is possible, in the case of too large a fastening allowance, to avoid brazing and fixing in a state where the pitch between the stacked thin-plate fins 2 is disrupted or the clearance between adjacent thin-plate fins 2 is narrowed, a high-performance heat exchanger can be obtained.

Since it is not necessary to restrain the flat heat transfer tubes 1 with a restraining jig etc. in the stage before inserting the thin-plate fins 2 across the flat heat transfer tubes 1, the time required for manufacturing the heat exchanger can be reduced.

### Embodiment 2.

FIG. 9 is a view showing the configuration of a refrigeration cycle apparatus according to Embodiment 2 of the present invention. In this embodiment, a refrigeration cycle apparatus which employs the above-described heat exchanger 20 as an outdoor-side heat exchanger 103 will be described. Here, an air-conditioning apparatus will be described as a typical example of the refrigeration cycle apparatus. The air-conditioning apparatus shown in FIG. 9 includes an outdoor unit 100 and an indoor unit 200, and circulates refrigerant in a refrigerant circuit configured by coupling these units with each other through refrigerant pipes. Of these refrigerant pipes, a pipe through which refrigerant in the form of gas (gas refrigerant) flows will be referred to as a gas pipe 300, and a pipe through which refrigerant in the form of liquid (liquid refrigerant, which may be a two-phase gas-liquid refrigerant) flows will be referred to as a liquid pipe 400.

In this embodiment, the outdoor unit 100 is composed of a compressor 101, a four-way valve 102, the outdoor-side heat exchanger 103, an outdoor-side fan 104, and an expansion device (expansion valve) 105.

The compressor 101 compresses suctioned refrigerant and discharges the compressed refrigerant. For example, the compressor 101 should be a compressor of which the operation frequency can be arbitrarily changed so as to finely change the capacity (the amount of refrigerant sent out per unit time) of the compressor 101. The four-way valve 102 switches the flow of refrigerant between cooling operation and heating operation on the basis of a command from a controller (not shown).

The outdoor-side heat exchanger 103, which is constituted by the above-described heat exchanger 20, performs heat exchange between refrigerant and air (outdoor air). For example, the outdoor-side heat exchanger 103 functions as an evaporator during heating operation. It performs heat exchange between air and low-pressure refrigerant flowing in from the liquid pipe 400 to evaporate and gasify the refrigerant. During cooling operation, on the other hand, the outdoor-side heat exchanger 103 functions as a condenser. It performs heat exchange between air and refrigerant flowing in from the side of the four-way valve 102 and compressed in the compressor 101, to condense and liquefy the refrigerant. The outdoor-side fan 104 sends air into the outdoor-side heat exchanger 103. For the outdoor-side fan 104 as well, the operating frequency of the fan motor may be arbitrarily changed through an inverter device so as to finely change the rotational speed. The expansion device 105 is provided to adjust the pressure of the refrigerant etc. by changing the opening degree.

On the other hand, the indoor unit 200 is composed of a load-side heat exchanger 201 and a load-side fan 202. The load-side heat exchanger 201 performs heat exchange between refrigerant and air. For example, the load-side heat exchanger 201 functions as a condenser during heating operation. It performs heat exchange between air and refrigerant flowing in from the gas pipe 300 to condense and liquefy the refrigerant (or turns it into two-phase gas-liquid refrigerant), and releases the refrigerant toward the liquid pipe 400. During cooling operation, on the other hand, the load-side heat exchanger 201 functions as an evaporator. For example, it performs heat exchange between air and refrigerant which is depressurized to a low pressure by the expansion device 105, has the refrigerant take the heat of the air so as to evaporate and gasify, and releases the refrigerant toward the gas pipe 300. The indoor unit 200 is provided with the load-side fan 202 which adjusts the flow of air used for heat exchange. The operating speed of this load-side fan 202 is determined, for example, by setting of a user.

Here, for the above-described refrigeration cycle apparatus, the following refrigerants may be used: HCFC (R22) and HFC (R116, R125, R134a, R14, R143a, R152a, R227ea, R23, R236ea, R236fa, R245ca, R245fa, R32, R41, RC318, etc., and mixed refrigerants of more than one type of these refrigerants, such as R407A, R407B, R407C, R407D, R407E, R410A, R410B, R404A, R507A, R508A, and R508B), HC (butane, isobutane, ethane, propane, propylene, etc., and mixed refrigerants of more than one type of these refrigerants), natural refrigerants (air, carbon dioxide gas, ammonia, etc., and mixed refrigerants of more than one type of these refrigerants), low-GWP refrigerants such as HFO1234yf, and mixed refrigerants of more than one type of these refrigerants, etc.

The above-described refrigeration cycle apparatus can achieve its effects with any refrigerating machine oil, for example, mineral oil, alkylbenzene oil, ester oil, ether oil, or fluorine oil, regardless of whether the refrigerant dissolves in the oil or not.

Moreover, the same effects can be obtained also when the heat exchanger 20 of Embodiment 1 described above is used for the load-side heat exchanger 201 of the indoor unit 200.

Thus, in the refrigeration cycle apparatus of Embodiment 2, since the heat exchanger 20 described in Embodiment 1 is used as the outdoor-side heat exchanger 103, the heat exchange performance can be improved.

While the example where the heat exchanger 20 is employed as the outdoor-side heat exchanger 103 has been described in this embodiment, the present invention is not limited to this example. For example, the heat exchanger 20 may be applied to the load-side heat exchanger 201.

### REFERENCE SIGNS LIST

1 flat heat transfer tube 2 thin-plate fin 4 cutout 4a, 4b, 4d open hole 4c cut 5 cut-and-raised slit 12 insert device 13 table 13a fixing jig 20 heat exchanger 21 fin collar 23 punch 24 die 26 restriking punch 100 outdoor unit 101 compressor 102 four-way valve 103 outdoor-side heat exchanger 104 outdoor-side fan 105 expansion device 200 indoor unit 201 load-side heat exchanger 202 load-side fan 300 gas pipe 400 liquid pipe

1. A manufacturing method of a heat exchanger including a plurality of flat heat transfer tubes having a flat shape in cross-section, and a plurality of fins having cutouts formed so as to match a shape of the flat heat transfer tube and fin collars formed so as to rise along edges of the cutouts, the plurality of fins being arrayed at predetermined intervals in a flow passage direction of each of the flat heat transfer tubes, the manufacturing method comprising:
molding the fin collar by pushing out and bending with a punch and a die of a pressing device to form an angle narrower than 90 degrees at a root portion thereof; and
remolding the fin collar by bending with a restriking punch to form an angle of 90 degrees with respect to a plate surface portion to have a fastening allowance of 0.10 mm to 0.25 mm with respect to an outer width dimension of each flat heat transfer tube.

2. (canceled)

3. The manufacturing method of a heat exchanger of claim 1,
wherein the fin collar formed along the edge of the cutout is formed so that a dimension between portions of the fin collar facing each other is constant.

4-5. (canceled)

6. A refrigeration cycle apparatus, comprising
a compressor compressing refrigerant and discharging the compressed refrigerant, a condenser condensing the refrigerant through heat exchange, an expansion device depressurizing the condensed refrigerant, and an evaporator exchanging heat between the depressurized refrigerant and air to evaporate the refrigerant connected by pipes to configure a refrigerant circuit,
at least one of the evaporator and the condenser including a heat exchanger manufactured by the method of claim 1.
